(19) United States
(12) Patent Application Publication
(10) Pub. No.: US 2010/0233335 A1
(43) Pub. Date: Sep. 16, 2010

(54) STAGGERED FILTRATION SYSTEM AND METHOD FOR USING THE SAME FOR PROCESSING FLUIDS SUCH AS OILS

(76) Inventor: Massoud Jalalpoor, Schifferstadt (DE)

Correspondence Address: WILLIAM D. BUNCH, W R GRACE & CO. CONN, PATENT DEPATMENT, LEGAL, SERVICES GROUP 7500 GRACE DRIVE, COLUMBIA, MD, 21044, US

(21) Appl. No.: 12/310,579

(22) PCT Filed: Aug. 30, 2007
(86) PCT No.: PCT/EP2007/007595

§ 371 Date: Feb. 27, 2009

Related U.S. Application Data
(60) Provisional application No. 60/842,067, filed on Sep. 1, 2006.

(51) Int. Cl. B01D 36/00; A23D 9/00

(52) U.S. Cl. 426/417; 210/201

(57) ABSTRACT

A staggered filtration system suitable for use in fluid processing is disclosed. A method of using a staggered filtration system to process fluids, such as oils, edible oils, fats, and similar materials, is also disclosed.

### FIELD OF THE INVENTION

The present invention is directed to a staggered filtration system useful for processing fluids such as oils, fats, and similar fluids including edible oils. The present invention is further directed to methods of using a staggered filtration system for processing fluids such as oils, fats, and similar fluids including edible oils.

### BACKGROUND OF THE INVENTION

Known methods and systems for processing oils, such as edible oil, possess one or more inefficiencies that add costs and/or fail to maximize oil output. Typical inefficiencies of known methods and systems for processing oil include, but are not limited to, (i) one or more production bottlenecks within the process, (ii) frequent filter changes during a given oil process cycle, and (iii) inefficient use of filtration aids/adsorbents, such as clay, within the process.

There is a need in the art for more efficient and effective methods for cost-effectively processing fluids, such as oils, fats, and similar fluids including edible oils.

### SUMMARY OF THE INVENTION

The present invention is directed to methods and systems for processing fluids such as oils, fats, and similar fluids, wherein the methods and systems eliminate one or more inefficiencies present in known methods and systems for processing fluids such as oils, fats, and similar fluids, such as methods and systems for producing edible oils. The methods and systems of the present invention utilize a staggered filtration system for processing fluids so as to (i) minimize potential production bottlenecks within the process, (ii) reduce the frequency of filter changes and/or cleaning while processing the fluid (e.g., oils, fats, and similar fluids including edible oil), (iii) efficiently utilize filtration aids/adsorbents, such as clay, within the process, (iv) use less adsorbent/clay within the process, which results in less fluid losses and less filter cake to be disposed of, or (v) any combination of (i) to (iv).

The present invention is directed to methods of processing a fluid, such as an edible oil, (or a fat or any similar material) using a staggered filtration system. In one exemplary embodiment, the method of processing a fluid using a staggered filtration system comprises the steps of passing the fluid (e.g., oil, fat, or similar fluid) through two or more pre-bleaching filters, wherein the two or more pre-bleaching filters are in parallel with one another; and filtering the oil through one or more post-bleaching filters, wherein the one or more post-bleaching filters are in parallel with one another and in series with the two or more pre-bleaching filters; wherein the staggered filtration system has a ratio of pre-bleaching filters to post-bleaching filters of greater than 1:1. In this exemplary embodiment, the method may further comprise a number of additional process steps typically used in known methods of processing oils (or fats or any other similar material). Suitable additional process steps may include, but are not limited to, an impurity-removal step using adsorbent particles, a drying step, a bleaching step, a fluid (e.g., oil, fat, or similar fluid) storing step, and a deodorizing step. The methods of the present invention are particularly useful in the production of edible oils.

In a further exemplary embodiment, the method of processing a fluid (e.g., oil, fat, or similar fluid) using a staggered filtration system comprises a method of producing edible oil (or fat or any other similar material) using a staggered filtration system, wherein the method comprises the steps of passing the oil (or fat or any other similar material) through the staggered filtration system during a process flow step so that the oil (or fat or any other similar material) passes through (i) two or more pre-bleaching filters A and B, wherein the two or more pre-bleaching filters are in parallel with one another, and (ii) one or more post-bleaching filters C, wherein the one or more post-bleaching filters are in parallel with one another and in series with the two or more pre-bleaching filters; and passing the oil (or fat or any other similar material) through the staggered filtration system during a subsequent process flow step in which at least one of post-bleaching filters C becomes a pre-bleaching filter. During the subsequent process flow step in which at least one of post-bleaching filters C becomes a pre-bleaching filter, at least one of pre-bleaching filters A and B typically becomes a post-bleaching filter. Desirably, during any given process flow step, the staggered filtration system comprises more pre-bleaching filters than post-bleaching filters. In this exemplary method, the staggered filtration system typically comprises a ratio of pre-bleaching filters to post-bleaching filters of greater than about 1.1:1, and in some cases, greater than about 2.0:1 or higher.

The present invention is further directed to an apparatus suitable for processing a fluid (e.g., oil, fat, or similar fluid). In one exemplary embodiment, the apparatus suitable for processing a fluid (e.g., oil, fat, or similar fluid) comprises (a) a bleaching unit; and (b) a staggered filtration system in-line with the bleaching unit, wherein the staggered filtration system comprises (i) two or more pre-bleaching filters positioned before the bleaching unit, wherein the two or more pre-bleaching filters are in parallel with one another, and (ii) one or more post-bleaching filters positioned after the bleaching unit, wherein the one or more post-bleaching filters are in parallel with one another and in series with the two or more pre-bleaching filters; wherein the staggered filtration system has a ratio of pre-bleaching filters to post-bleaching filters of greater than 1:1. The exemplary apparatus may further comprise additional apparatus components typically found in oil processing apparatus. Suitable additional components include, but are not limited to, a mixing vessel suitable for bringing the fluid (e.g., oil, fat, or similar fluid) into contact with a plurality of absorbent particles so as to reduce an amount of impurities within the fluid (e.g., oil, fat, or similar fluid), a dryer, a fluid (e.g., oil, fat, or similar fluid) storage vessel, or any combination thereof.

These and other features and advantages of the present invention will become apparent after a review of the following detailed description of the disclosed embodiments and the appended claims.

### BRIEF DESCRIPTION OF THE FIGURES

FIG. 1 depicts a schematic diagram of an exemplary apparatus comprising a staggered filtration system suitable for processing a fluid (e.g., oil, fat, or similar fluid) according to the present invention;

FIGS. 2A-2F depict schematic diagrams of exemplary process cycles suitable for processing a fluid (e.g., oil, fat, or similar fluid) using a staggered filtration system according to the present invention; and

FIGS. 3A-3E depict a flow diagram of an exemplary method of processing an oil using a staggered filtration system according to the present invention.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to a staggered filtration system suitable for use in methods of processing fluids (e.g., oil, fat, or similar fluid), such as edible oil. The present invention is further directed to methods of making fluids, such as edible oil, fats, or similar materials using a staggered filtration system. A description of exemplary methods of processing fluids (e.g., oil, fat, or similar fluid) is provided below.

As used herein, the term “oil” is used to describe oils, fats, and triglycerides; oil-, fat- and triglyceride-containing fluids, as well as oil-, fat- and triglyceride precursor fluids that are convertible into oils, fats, triglycerides, edible oils, or biodiesel fuel (e.g., triglycerides). Although the processes described herein are described in terms of oil processing so as to produce, for example, bleached oil, the disclosed process may be used to process other fluids including fats and similar materials.

As used herein, the term “adsorbent particles” comprises any commercially available adsorbents, including natural or synthetic adsorbents comprising organic (e.g., natural and synthetic polymers, etc.) and/or inorganic materials (e.g. inorganic oxides such as clay, silica, alumina, etc.). Examples include natural minerals, processed/activated minerals, montmorillonite, attapulgite, bentonite, palygorskite, Fuller's earth, diatomite, smectite, hormite, quartz sand, limestone, kaolin, ball clay, talc, pyrophyllite, perlite, sodium silicate, sodium aluminum silicate, magnesium silicate, magnesium aluminum silicate, silica hydrogel, silica gel, colloidal silica, fumed silica, precipitated silica, dialytic silica, fibrous materials, cellulose, cellulose esters, cellulose ethers, microcrystalline cellulose; alumina zeolite, starches, molecular sieves, diatomaceous earth, ion exchange resin, size exclusion chromatography resin, chelating resins, rice hull ash, reverse phase silica, bleaching Clay, and all types of activated carbons, and mixtures thereof. Commercially available silica particles include, but are not limited to, TriSyl® silica hydrogel particles commercially available from W.R. Grace (Columbia, Md.). A description of TriSyl® silica hydrogel particles may be found in U.S. Pat. Nos. 5,336,794, 5,231,201, 4,939,115, 4,734,226, and 4,629,588, the subject matter of each of which is hereby incorporated by reference in its entirety.

### I. Apparatus Suitable for Processing Fluids Such as Oil

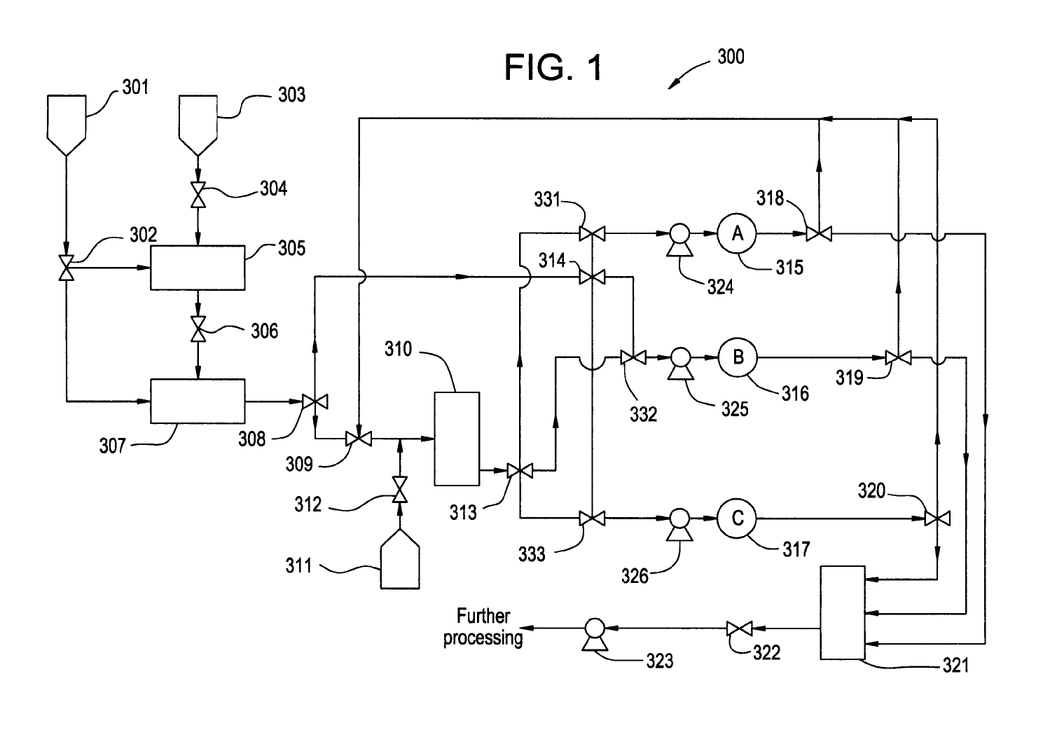

The present invention is directed to an apparatus suitable for processing a fluid (e.g., oil, fat, or similar fluid), such as an oil, so as to produce a filtered fluid having less impurities when compared to the pre-processed fluid. The apparatus of the present invention are particularly useful in the production of edible oils. In one exemplary embodiment, the apparatus of the present invention comprises a staggered filtration system in-line with a bleaching unit, wherein the staggered filtration system comprises (i) two or more pre-bleaching filters positioned before the bleaching unit, wherein the two or more pre-bleaching filters are in parallel with one another, and (ii) one or more post-bleaching filters positioned after the bleaching unit, wherein the one or more post-bleaching filters are in parallel with one another and in series with the two or more pre-bleaching filters. The apparatus of the present invention may further comprise a number of additional apparatus components typically found in fluid (e.g., oil, fat, or similar fluid) processing apparatus including, but are not limited to, a mixing vessel suitable for bringing the fluid (e.g., oil, fat, or similar fluid) into contact with a plurality of absorbent particles so as to reduce an amount of impurities within the fluid, a dryer, a fluid (e.g., oil, fat, or similar fluid) storage vessel, one or more flow valves, and process control equipment. One exemplary apparatus of the present invention is shown in FIG. 1.

As shown in FIG. 1, exemplary apparatus 300 comprises the following components: incoming fluid (e.g., oil, fat, or similar fluid) storage container 301; absorbent particle storage container 303; valve 302 for controlling the flow rate of incoming fluid (e.g., oil, fat, or similar fluid) into mixing vessel 305 or into dryer 307; valve 304 for controlling the flow rate of absorbent particles into mixing vessel 305; valve 306 for controlling the flow rate of a fluid/absorbent particle mixture into dryer 307; valve 308 for controlling the flow rate of dried fluid (e.g., oil, fat, or similar fluid) into any of filters 315, 316 or 317 or into bleaching unit 310; valve 309 for controlling the flow rate of filtered fluid (e.g., oil, fat, or similar fluid) from any of filters 315, 316 or 317 into bleaching unit 310; clay storage container 311; valve 312 for controlling the flow rate of clay into bleaching unit 310; valves 313, 331, 332, and 333, and pumps 324, 325 and 326 for controlling the flow rate of bleached fluid (e.g., oil, fat, or similar fluid) into filter 315, filter 316, filter 317, or any combination thereof; valves 314, 331, 332, and 333, and pumps 324, 325 and 326 for controlling the flow rate of dried fluid (e.g., oil, fat, or similar fluid) into filter 315, filter 316, filter 317, or any combination thereof; valves 318, 319, and 320 for controlling the flow rate of filtered fluid (e.g., oil, fat, or similar fluid) from filters 315, 316 and 317 respectively to bleaching unit 310 or to processed fluid (e.g., oil, fat, or similar fluid) storage unit 321; valve 322 for controlling the flow rate of processed fluid (e.g., oil, fat, or similar fluid) out of exemplary apparatus 300 for further processing, such as in a deodorizing step, etc.; and pump 323 for moving fluid out of exemplary apparatus 300 toward further fluid processing equipment (e.g., a deodorizer, etc.). Although four pumps are shown in FIG. 1, it should be noted that exemplary apparatus 300 may actually comprise more pumps (e.g., a pump for each filter and/or for each three-way flow valve).

It should be noted that exemplary apparatus 300 shown in FIG. 1 is only one possible apparatus containing a staggered filtration system, and various configuration changes are possible in any given apparatus. For example, although not shown in exemplary apparatus 300, apparatus of the present invention could comprise two or more filters, and typically comprises from 3 to 15 filters, each of which are positioned within a staggered filtration system as shown in exemplary apparatus 300 of FIG. 1. It should be noted that the present invention is directed to any apparatus that comprises the staggered filtration system as described herein.

As noted in exemplary apparatus 300 (and any other apparatus of the present invention), incoming fluid (e.g., oil, fat, or similar fluid) may be processed (1) through one or more of exemplary filters 315, 316 and 317 via valves 308, 314, 331, 332, and 333, and pumps 324, 325 and 326 prior to being processed through bleaching unit 310 and (2) through one or more of exemplary filters 315, 316 and 317 via valves 308, 309, 313, 331, 332, and 333, and pumps 324, 325 and 326 after being processed through bleaching unit 310. The configuration of exemplary apparatus 300 (and any other apparatus of the present invention) enables enhanced flexibility with regard to fluid flow prior to and after bleaching unit 310 so as to minimize any bottlenecks in the flow process. For example, in exemplary apparatus 300, any two of filters 315, 316 and 317 may be used as pre-bleaching filters (e.g., valve 314 provides fluid flow to filters 315 and 316, but not filter 317), while any one of filters 315, 316 and 317 is used as a post-bleaching filter (e.g., valve 313 provides fluid flow to filter 317, but not filters 315 and 316) so as to minimize any potential bottlenecks in the pre-bleaching filtering stage of the flow process.

In one exemplary embodiment of the present invention, the apparatus suitable for processing a fluid (e.g., oil, fat, or similar fluid) comprises a bleaching unit; and a staggered filtration system in-line with the bleaching unit, the staggered filtration system comprising two or more pre-bleaching filters positioned before the bleaching unit, wherein the two or more pre-bleaching filters are in parallel with one another, and one or more post-bleaching filters positioned after the bleaching unit, wherein the one or more post-bleaching filters are in parallel with one another and in series with the two or more pre-bleaching filters. Desirably, the staggered filtration system has a ratio of pre-bleaching filters to post-bleaching filters of greater than 1:1. As used herein, the phrase “before the bleaching unit” is used to describe a filter in-line with a bleaching unit such that fluid (e.g., oil, fat, or similar fluid) passes through the filter “before” passing through the bleaching unit during a given process flow step. As used herein, the phrase “after the bleaching unit” is used to describe a filter in-line with a bleaching unit such that fluid (e.g., oil, fat, or similar fluid) passes through the filter “after” passing through the bleaching unit during a given process flow step.

As shown in FIG. 1, exemplary apparatus 300 comprising bleaching unit 310 and a staggered filtration system in-line with the bleaching unit 310 may further comprise (1) mixing vessel 305 in-line with bleaching unit 310 and the staggered filtration system, wherein mixing vessel 305 is suitable for bringing the fluid (e.g., oil, fat, or similar fluid) into contact with a plurality of absorbent particles so as to reduce an amount of impurities within the fluid; (2) a dryer 307 in-line with mixing vessel 305, bleaching unit 310, and the staggered filtration system; and (3) a fluid (e.g., oil, fat, or similar fluid) storage vessel 321 in-line with mixing vessel 305, bleaching unit 310, the staggered filtration system, and dryer 307. Further, as shown in FIG. 1, exemplary apparatus 300 may also comprise one or more flow valves (e.g., flow valves 308, 309, 313, 314, 318, 319 and 320) capable of routing the fluid (e.g., oil, fat, or similar fluid) along a different pathway through the staggered filtration system from one process flow step to a subsequent process flow step (described further below).

Although not shown in FIG. 1, exemplary apparatus 300 may further comprise process control equipment capable of opening and closing one or more flow valves within the apparatus so as to route the fluid (e.g., oil, fat, or similar fluid) along a different pathway through the staggered filtration system from one process flow step to a subsequent process flow step. Other process control equipment (not shown) may be used to provide a number of process control functions including, but not limited to, in-line, real-time monitoring of one or more fluid streams (e.g., a contaminant concentration in a given fluid stream, a temperature of a fluid stream, a color of a fluid stream, etc.) in one or more locations throughout a given apparatus; monitoring of pressure build-up in one or more locations throughout a given apparatus (e.g., at one or more of filters 315, 316 and 317); measuring fluid flow rates in one or more locations throughout a given apparatus; activating and turning off one or more pumps; providing automatic shut-down in case of an apparatus malfunction (e.g., a leak or excessively higher than normal pressure); etc.

### II. Methods of Processing Fluids

The present invention is further directed to methods of processing a fluid (e.g., oil, fat, or similar fluid) using a staggered filtration system such as in exemplary apparatus 300 shown in FIG. 1. In one exemplary embodiment, the method of processing a fluid (e.g., oil, fat, or similar fluid) using a staggered filtration system comprises the steps of passing the fluid through two or more pre-bleaching filters, wherein the two or more pre-bleaching filters are in parallel with one another; and filtering the oil through one or more post-bleaching filters, wherein the one or more post-bleaching filters are in parallel with one another and in series with the two or more pre-bleaching filters. The staggered filtration system may have a ratio of pre-bleaching filters to post-bleaching filters of equal to or greater than 1:1. As used herein, the term “pre-bleaching filter or filters” is used to describe one or more filters in-line with a bleaching unit such that fluid (e.g., oil, fat, or similar fluid) passes through the one or more filters prior to passing through the bleaching unit during a given process flow step. As used herein, the term “post-bleaching filter or filters” is used to describe one or more filters in-line with a bleaching unit such that fluid (e.g., oil, fat, or similar fluid) passes through the one or more filters after passing through the bleaching unit during a given process flow step.

In this exemplary embodiment, the method may further comprise a number of additional process steps typically used in known methods of processing fluids (e.g., oils, fats, or similar fluids). Suitable additional process steps may include, but are not limited to, a fluid drying step (e.g., a volatiles removal step), an impurity-removal step using absorbent particles, a bleaching step, a fluid storing step, and a deodorizing step.

A description of one or more suitable steps in the methods of the present invention is provided below.

A. Steps for Processing Fluids Such as in the Production of Edible Oils

The following steps may be used to process fluids (e.g., oils, fats, or similar fluids) according to the methods of the present invention.

1. Fresh Clay Treatment Step

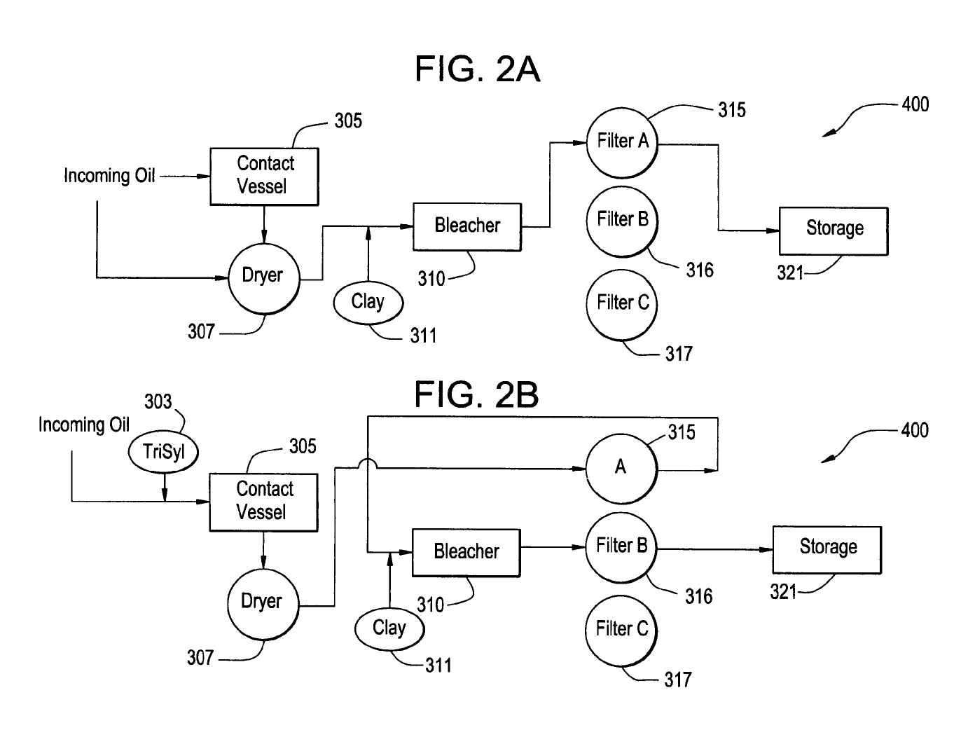

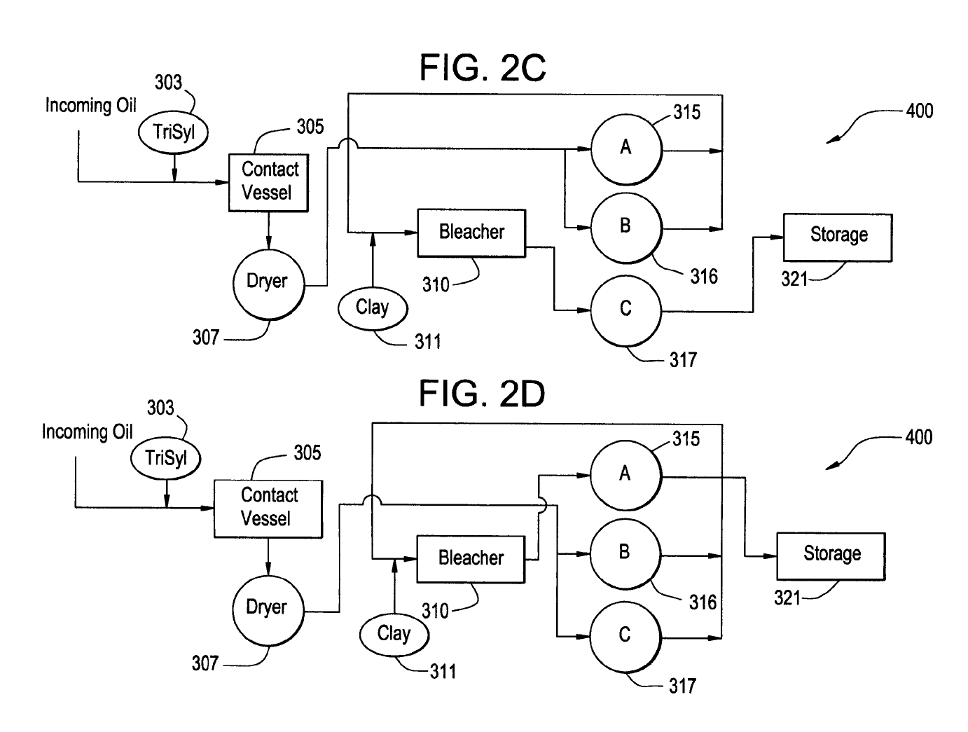

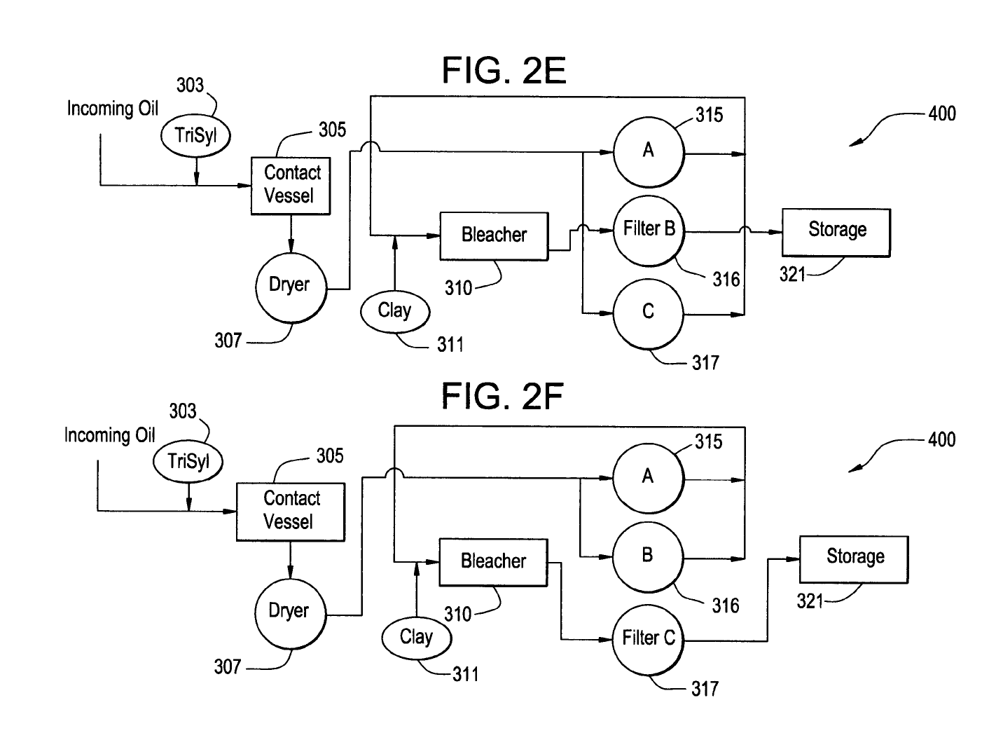

The methods of the present invention desirably comprise one or more fresh clay treatment steps, wherein an effective amount of fresh clay is introduced into a fluid stream (or introduced into a bleacher through which the fluid stream passes) for the purpose of removing color from the fluid. Exemplary fresh clay treatment steps are shown in exemplary method 400 of FIGS. 2A-2F. During a given fresh clay treatment step, fresh clay from clay storage container 311 is inputted into the fluid stream (or introduced into bleaching unit 310), which results in the formation of a layer of fresh clay at least a portion of an inlet surface, desirably over the entire inlet surface, of one or more post-bleaching filters (e.g., one or more of filters 315, 316 and 317). As shown in FIG. 2A, which is also referred to herein as “Process Flow Step 1” of exemplary method 400, incoming fluid (e.g., oil, fat, or similar fluid) bypasses mixing vessel 305 and proceeds through dryer 307. From dryer 307, the fluid (e.g., oil, fat, or similar fluid) proceeds to a point prior to bleaching unit 310 where fresh clay from clay storage container 311 is inputted into the fluid stream. The clay-containing fluid stream then proceeds to bleaching unit 310, and subsequently through post-bleaching filter 315. At this time, post-bleaching filter 315 is coated with a layer of fresh. After leaving filter 315, the fluid proceeds to processed fluid storage unit 321. It should be noted that the bleached fluid leaving filter 315 could bypass fluid storage unit 321 and proceed directly to other process steps, such as a deodorizing step (not shown).

It should be noted that a fresh clay treatment step, as described above, takes place in each of the process flow steps shown in FIGS. 2A-2F. For example, a layer of fresh clay is applied onto at least a portion of an inlet surface (desirably, the entire inlet surface) of post-bleaching filter 315 in Process Flow Steps 1 and 4; post-bleaching filter 316 in Process Flow Steps 2 and 5; and post-bleaching filter 317 in Process Flow Steps 3 and 6. The fresh clay treatment step is one step in the process of converting a post-bleaching filter to a pre-bleaching filter as described above and as shown in FIGS. 2A-2F.

The amount of fresh clay used during a given fresh clay treatment step is dependent on a customer's required color specifications in the bleached/post-filtered fluid. For example, an initial fresh clay treatment of a fluid stream prior to any other fluid treatment step typically requires a relatively high ratio of inputted fresh clay to processed fluid. In contrast, fresh clay treatment of a fluid stream after a absorbent treatment step (described below) and a pre-filtration step (i.e., filtration of the fluid/absorbent mixture with a spent/used clay-coated filter formed during the fresh clay treatment step described above) requires a relatively low amount of inputted fresh clay given that the processed fluid at this stage is much cleaner.

2. Absorbent Treatment Step

In the methods of the present invention, processable fluid (e.g., oil, fat, or similar fluid) is desirably brought into contact with adsorbent particles in order to reduce the level of one or more impurities (e.g., phospholipids, soaps, trace metals, or a combination thereof) to a desired level in the fluid. Typically, the adsorbent treatment step reduces the amount of phosphorus in the fluid (e.g., oil, fat, or similar fluid) to less than about 10 ppm (or less than about 9, or less than about 8, or less than about 7, or less than about 6, or less than about 5, or less than about 4, or less than about 3, or less than about 2, or less than about 1 ppm). For example, in the production of edible oil, the amount of phosphorus in the fluid is reduced to below 1 ppm. Exemplary adsorbent treatment steps are shown in FIGS. 2B-2F, which are also referred to respectively herein as “Process Flow Steps 2 to 6.”

In this step of the present invention, any commercially available adsorbent particles may be used for contacting the fluid (e.g., oil, fat, or similar fluid). Commercially available adsorbent particles include, but are not limited to, TriSyl® adsorbent hydrogel particles commercially available from W.R. Grace (Columbia, Md.). A description of TriSyl® adsorbent hydrogel particles may be found in U.S. Pat. Nos. 5,336,794, 5,231,201, 4,939,115, 4,734,226, and 4,629,588, the subject matter of each of which is hereby incorporated by reference in its entirety.

In this step, a controlled amount of adsorbent particles is introduced into the fluid (e.g., oil, fat, or similar fluid) via adsorbent particle storage container 303 and mixed with the fluid (e.g., oil, fat, or similar fluid) in mixing vessel 305. An effective amount of adsorbent particles is used in order to reduce the amount of phosphorus in the fluid (e.g., oil, fat, or similar fluid) to a desired level (e.g., typically, less than 1 ppm in the production of edible oil). The effective amount of adsorbent particles necessary to reduce the amount of phosphorus in the fluid (e.g., oil, fat, or similar fluid) to a desired level differs depending on the type of adsorbent particles used, the starting fluid (e.g., oil, fat, or similar fluid), and the customer's required specifications for the processed fluid.

In one desired embodiment of the present invention, an effective amount of TriSyl® adsorbent hydrogel particles commercially available from W.R. Grace (Columbia, Md.) is used. See, for example, European Patent Applications EP 0185 182 A1 and EP 05707 424 A1, which disclose the use of an effective amount of TriSyl® adsorbent hydrogel particles to reduce the amount of phosphorus in degummed triglycerides in the preparation of edible oils, the subject matter of each of which is hereby incorporated by reference in its entirety. It has been discovered that a smaller concentration of TriSyl® adsorbent hydrogel particles (e.g., the ratio of the mass of adsorbent particles to the mass or volume of fluid) is needed to reduce the amount of phosphorus in the fluid (e.g., oil, fat, or similar fluid) to a desired level due to the superior adsorption properties of TriSyl® adsorbent hydrogel particles.

Typically, fluid (e.g., oil, fat, or similar fluid) is mixed with adsorbent particles (e.g., in mixing vessel 305) under atmospheric pressure (or low vacuum) for a time period ranging from about 15 minutes to about 45 minutes in order to effectively remove phospholipids, trace metals, and soaps from the fluid. In some embodiments, effective removal of phosphorus from the fluid (e.g., oil, fat, or similar fluid) using adsorbent particles takes place within a time period ranging from about 15 minutes to about 20 minutes (e.g., total mixing time from initial contact to the beginning of a drying step).

Prior to being brought into contact with the adsorbent particles, the fluid (e.g., oil, fat, or similar fluid) may be preheated to a desired temperature. Any conventional heat exchanger (not shown) may be used to preheat the fluid (e.g., oil, fat, or similar fluid). In one exemplary embodiment, the fluid (e.g., oil, fat, or similar fluid) is preheated to a desired temperature ranging from about 60° C. to about 90° C., desirably about 80° C.

Following the mixing step, the fluid/adsorbent particle mixture is typically dried in dryer 307 to remove volatile components from the fluid. Once the fluid (e.g., oil, fat, or similar fluid)/adsorbent particle mixture is dried and the amount of phosphorus and other impurities in the fluid (e.g., oil, fat, or similar fluid) are reduced to a desired level, the fluid/adsorbent particle mixture is further processed through a filtration step as shown in FIGS. 2B-2F.

3. Pre-Bleaching Filtration Step

As shown in Process Flow Step 2 of exemplary method 400 (e.g., FIG. 2B), the dried fluid (e.g., oil, fat, or similar fluid)/adsorbent particle mixture proceeds to pre-bleaching filter 315 in order to separate the fluid (e.g., oil, fat, or similar fluid) from the adsorbent particles. As shown in FIGS. 2A-2B, pre-bleaching filter 315 of Process Flow Step 2 is post-bleaching filter 315, which was previously coated with fresh clay from the preceding step, Process Flow Step 1. Any type of filter may be used for pre-bleaching filter 315 (and filters 316 and 317) including, but not limited to, pressure leaf filters, plate & frame filters, candle filters and membrane filters.

Once separated from the fluid (e.g., oil, fat, or similar fluid), the adsorbent particles/spent clay may be disposed of using conventional disposal techniques. As shown in FIG. 2B (as well as FIGS. 2C-2F), following a pre-bleaching filtration step, the resulting adsorbent-treated fluid (e.g., oil, fat, or similar fluid) is further processed by introducing fresh clay from clay storage container 311 into the adsorbent-treated fluid stream prior to entering bleaching unit 310. The clay-containing, adsorbent-treated, fluid stream then proceeds to bleaching unit 310, and through post-bleaching filter 316. At this time, post-bleaching filter 316 is coated, as described above, with a layer of fresh clay along at least a portion of an inlet surface (desirably, the entire inlet surface) of post-bleaching filter 316. (Post-bleaching filter 316 becomes a pre-bleaching filter in the next process flow step, Process Flow Step 3, as described below.)

After leaving post-bleaching filter 316, the adsorbent-treated fluid proceeds to processed fluid storage unit 321. As noted above, the bleached fluid leaving post-bleaching filter 316 could bypass fluid storage unit 321 and proceed directly to other process steps, such as a deodorizing step (not shown).

4. Bleaching Step

As shown in FIGS. 1-2F, in the methods of the present invention, fluid is processed through a bleaching unit, such as exemplary bleaching unit 310, in order to remove one or more contaminants and/or improve the color of the fluid. Any conventional bleaching unit may be used in the present invention.

5. Post-Bleaching Filtration Step

As shown in FIGS. 2A-2F, in the methods of the present invention, fluid is processed through a bleaching unit, and subsequently through one or more post-bleaching filers. As shown in Process Flow Step 3 of exemplary method 400 (e.g., FIG. 2C), incoming fluid is adsorbent treated and dried as described above, for example, in Process Flow Step 2. The adsorbent-treated, dried fluid then proceeds through parallel pre-bleaching filters 315 and 316 (formed in Process Flow Steps 1 and 2) in order to separate fluid from the adsorbent particles using two coated spent clay filters. As discussed above, any type of filter can be used in this step.

As shown in Process Flow Step 3 (e.g., FIG. 2C), the adsorbent-treated fluid exiting pre-bleaching filters 315 and 316 is further processed by introducing fresh clay from clay storage container 311 into the adsorbent-treated fluid stream prior to entering bleaching unit 310 It should be understood that although exemplary method 400 shown in FIGS. 2A-2F describes the introduction of fresh clay into the fluid prior to bleaching unit 310, fresh clay could also or alternatively be added directly to bleaching unit 310. The clay-containing, adsorbent-treated fluid stream then proceeds to bleaching unit 310, and through post-bleaching filter 317 so as to coat post-bleaching filter 317 with a layer of fresh clay along as described above. (Post-bleaching filter 317 becomes a pre-bleaching filter in the next process flow step, Process Flow Step 4, as described below.)

After leaving post-bleaching filter 317, the adsorbent-treated fluid proceeds to processed fluid storage unit 321 FIG. 2D. As noted above, the bleached fluid leaving post-bleaching filter 317 could bypass fluid storage unit 321 and proceed directly to other process steps, such as a deodorizing step (not shown).

As shown in Process Flow Step 4 of exemplary method 400 (e.g., FIG. 2D), incoming fluid is adsorbent treated and dried as described above (i.e., during Process Flow Steps 2 and 3). The adsorbent-treated, dried fluid then proceeds through parallel pre-bleaching filters 316 and 317 in order to separate fluid from the adsorbent particles using previously coated filters. The adsorbent-treated fluid exiting pre-bleaching filters 316 and 317 is further processed by introducing fresh clay from clay storage container 311 into the adsorbent-treated fluid stream prior to (or after) entering bleaching unit 310

The adsorbent-treated fluid stream then proceeds to bleaching unit 310, and through filter 315, which now acts as a post-bleaching filter. At this time, post-bleaching filter 315 is again coated with a layer of fresh clay along at least a portion of an inlet surface (desirably, the entire inlet surface) of post-bleaching filter 315 as described above. (Post-bleaching filter 315 becomes a pre-bleaching filter in the next process flow step, Process Flow Step 5, as described below.) After leaving post-bleaching filter 315, the adsorbent-treated fluid proceeds to processed fluid storage unit 321 FIG. 2E. As noted above, the bleached fluid leaving post-bleaching filter 315 could bypass fluid storage unit 321 and proceed directly to other process steps, such as a deodorizing step (not shown).

As shown in Process Flow Step 5 of exemplary method 400 (e.g., FIG. 2E), incoming fluid is adsorbent treated and dried as described above (i.e., during Process Flow Steps 2, 3, and 4). The adsorbent-treated, dried fluid then proceeds through pre-bleaching filters 315 and 317 in order to separate fluid from the adsorbent particles using the two most recently clay coated filters (i.e., pre-bleaching filters 315 and 317). The adsorbent-treated fluid exiting pre-bleaching filters 315 and 317 is further processed by introducing fresh clay, as discussed above, from clay storage container 311 into the adsorbent-treated fluid stream prior to (or after) entering bleaching unit 310

The adsorbent-treated fluid stream then proceeds to bleaching unit 310, and through filter 316, which now acts as a post-bleaching filter. At this time, post-bleaching filter 316 is again coated with a layer of fresh clay along at least a portion of an inlet surface (desirably, the entire inlet surface) of post-bleaching filter 316 as described above. (Post-bleaching filter 316 becomes a pre-bleaching filter in the next process flow step, Process Flow Step 6, as described below.)

After leaving post-bleaching filter 316, the adsorbent-treated fluid proceeds to processed fluid storage unit 321 FIG. 2F. As noted above, the bleached fluid leaving post-bleaching filter 316 could bypass fluid storage unit 321 and proceed directly to other process steps, such as a deodorizing step (not shown).

As shown in Process Flow Step 6 of exemplary method 400 (e.g., FIG. 2F), incoming fluid is adsorbent treated and dried as described above (i.e., during Process Flow Steps 2, 3, 4, and 5). The adsorbent-treated, dried fluid then proceeds through pre-bleaching filters 315 and 316 in order to separate fluid from the adsorbent particles using the two most recently coated filters (i.e., pre-bleaching filters 315 and 316). The adsorbent-treated fluid exiting pre-bleaching filters 315 and 316 is further processed by introducing fresh clay, as discussed above, from clay storage container 311 into the adsorbent-treated fluid stream prior to (or after) entering bleaching unit 310

The adsorbent-treated fluid stream then proceeds to bleaching unit 310, and through filter 317, which now acts as a post-bleaching filter. At this time, post-bleaching filter 317 is again coated with a layer of fresh clay along at least a portion of an inlet surface (desirably, the entire inlet surface) of post-bleaching filter 317. (Post-bleaching filter 317 becomes a pre-bleaching filter in the next process flow step, Process Flow Step 4, as described below.)

After leaving post-bleaching filter 317, the adsorbent-treated fluid proceeds to processed fluid storage unit 321. As noted above, the bleached fluid leaving post-bleaching filter 317 could bypass fluid storage unit 321 and proceed directly to other process steps, such as a deodorizing step (not shown). At this stage, the fluid has been processed so as to provide a desired processed fluid (e.g., the color and/or quality of the fluid meets or exceeds a customer's required specifications for the processed fluid).

In one exemplary embodiment of the present invention, the method of processing a volume of fluid (e.g., oil, fat, or similar fluid) comprises two or more complete cycles through the staggered filtration system (i.e., utilizing Process Flow Steps 1-6 one time and then utilizing Process Flow Steps 4-6 one or more times). For example, in a three-filter system as in exemplary method 400, a relatively large volume of fluid may be processed using Process Flow Steps 1-6 one time and then Process Flow Steps 4-6 one or more times with a minimum number of filter cleaning steps (described below) and without fluid bottlenecks in the system.

As shown above, exemplary method 400 containing Process Flow Steps 1-6 comprises successive process flow steps, generally referred to herein as successive process flow steps n and (n+1), in which filters A, B and C (represented by filters 315, 316, and 317 respectively) are utilized (e.g., the filters are in-line and in operation). Exemplary method 400 comprises a rotating flow configuration such that during process flow step n, filters A and B are pre-bleaching filters and filter C is a post-bleaching filter, and during process flow step (n+1), filters B and C are pre-bleaching filters and filter A is a post-bleaching filter. In the methods of the present invention, from one process flow step to a subsequent process flow step through the disclosed staggered filtration system, at least one post-bleaching filter becomes a pre-bleaching filter.

The rotation of a given filter from a post-bleaching filter status to a pre-bleaching filter status and vice versa in the staggered filtration system of exemplary method 400 is displayed in Table 1 below.

TABLE 1
Staggered Filter System Utilizing Three Filters

| Process | Filter | | |
|---|---|---|---|
| Flow Step | A | B | C |
| 1 | post-bleaching filter | stand-by | stand-by |
| 2 | pre-bleaching | post-bleaching filter | stand-by |
| | filter 1 | | |
| 3 | pre-bleaching | pre-bleaching | post-bleaching |
| | filter 2 | filter 1 | filter |
| 4 | post-bleaching filter | pre-bleaching | pre-bleaching |
| | after cleaning step | filter 2 | filter 1 |
| 5 | pre-bleaching | post-bleaching filter | pre-bleaching |
| | filter 1 | after cleaning step | filter 2 |
| 3 | pre-bleaching | pre-bleaching filter 1 | post-bleaching |
| | filter 2 | | filter after |
| | | | cleaning step |
| 4 | post-bleaching filter | pre-bleaching | pre-bleaching |
| | after cleaning step | filter 2 | filter 1 |
| 5 | pre-bleaching | post-bleaching filter | pre-bleaching |
| | filter 1 | after cleaning step | filter 2 |
| repeat 3-5 | | | |

As shown in Table 1, exemplary method 400 proceeds from one process flow step to the next process flow step, a given filter changes from a post-bleaching filter to a pre-bleaching filter 1 to a pre-bleaching filter 2 and, after cleaning, back to a post-bleaching filter and so on. Further, as shown in Table 1, in a three-filter staggered filter system such as exemplary method 400, a process cycle comprises three process flow steps, namely, process flow steps 3-5, which repeat any number of desired times.

In a five-filter staggered filter system utilizing three pre-bleaching filters and two post-bleaching filters, a similar rotation takes place as shown in Table 2 below.

TABLE 2
Staggered Filter System Utilizing Five Filters

| Process | | | | | |
|---|---|---|---|---|---|
| Flow | Filter | | | | |
| Step | A | B | C | D | E |
| 1 | post-bleaching | post-bleaching | stand-by | stand-by | stand-by |
| | filter 2 | filter 1 | | | |
| 2 | pre-bleaching | post-bleaching | stand-by | stand-by | stand-by |
| | filter 1 | filter 2 | | | |
| 3 | pre-bleaching | pre-bleaching | post-bleaching | stand-by | stand-by |
| | filter 2 | filter 1 | filter 1 | | |
| 4 | pre-bleaching | pre-bleaching | pre-bleaching | post-bleaching | post-bleaching |
| | filter 3 | filter 2 | filter 1 | filter 2 | filter 1 |
| 5 | post-bleaching | pre-bleaching | pre-bleaching | pre-bleaching | post-bleaching |
| | filter 1 after | filter 3 | filter 2 | filter 1 | filter 2 |
| | cleaning step | | | | |
| 6 | post-bleaching | post-bleaching | pre-bleaching | pre-bleaching | pre-bleaching |
| | filter 2 | filter 1 after | filter 3 | filter 2 | filter 3 |
| | | cleaning step | | | |
| 7 | pre-bleaching | post-bleaching | post-bleaching | pre-bleaching | pre-bleaching |
| | filter 1 | filter 2 | filter 1 after | filter 3 | filter 2 |
| | | | cleaning step | | |
| 3 | pre-bleaching | pre-bleaching | post-bleaching | post-bleaching | pre-bleaching |
| | filter 2 | filter 1 | filter 2 | filter 1 after | filter 3 |
| | | | | cleaning step | |
| 4 | pre-bleaching | pre-bleaching | pre-bleaching | post-bleaching | post-bleaching |
| | filter 3 | filter 2 | filter 1 | filter 2 | filter 1 after |
| | | | | | cleaning step |
| 5 | post-bleaching | pre-bleaching | pre-bleaching | pre-bleaching | post-bleaching |
| | filter 1 after | filter 3 | filter 2 | filter 1 | filter 2 |
| | cleaning step | | | | |
| 6 | post-bleaching | post-bleaching | pre-bleaching | pre-bleaching | pre-bleaching |
| | filter 2 | filter 1 after | filter 3 | filter 2 | filter 1 |
| | | cleaning step | | | |
| 7 | pre-bleaching | post-bleaching | post-bleaching | post-bleaching | pre-bleaching |
| | filter 1 | filter 2 | filter 1 after | filter 3 | filter 2 |
| | | | cleaning step | | |
| repeat 3-7 | | | | | |

As shown in Table 2, as the process proceeds from one process flow step to the next process flow step, a given filter changes from a post-bleaching filter 1 to a post-bleaching filter 2 to a pre-bleaching filter 1 to a pre-bleaching filter 2 to a pre-bleaching filter 3 and, after cleaning, back to a post-bleaching filter 1 and so on. Further, as shown in Table 2, in a five-filter staggered filter system utilizing three pre-bleaching filters and two post-bleaching filters, a process cycle comprises five process flow steps, namely, process flow steps 3-7, which repeat any number of desired times depending on the volume of incoming fluid to be processed.

In the methods of the present invention, the ratio of pre-bleaching filters to post-bleaching filters may be varied in order to minimize potential bottlenecks in the production line. Typically, the ratio of pre-bleaching filters to post-bleaching filters is equal to or greater than about 1:1. In other embodiments, the ratio of pre-bleaching filters to post-bleaching filters is greater than about 1.1:1, or greater than about 2.0:1 or higher. It should be understood that the ratio of pre-bleaching filters to post-bleaching filters can be any ratio, and typically is a ratio in which more pre-bleaching filters are present in the staggered filtration system compared to post-bleaching filters. Further, it should be understood that the staggered filtration system may comprise any number of in-line filters (e.g., the total number of in-line pre-bleaching and post-bleaching filters). Typically, the number of in-line filters ranges from about 3 to about 20 filters, more typically, from about 3 to about 15 filters, with the ratio of pre-bleaching filters to post-bleaching filters being at least 1.1:1.

6. Filter Cleaning Step

In additional to the above-described exemplary steps, the methods of the present invention may further comprise a filter cleaning step in which one or more of the filters (e.g., 315, 316, and 317) are cleaned so as to remove a buildup of materials from the filter. As described above, over time, each of the filters used in the staggered filtration system starts to form a buildup of fresh clay and adsorbent particles on an inlet side of the filter. Periodically, a given filter is cleaned so as to remove the buildup of materials from the filter. In most case, the filter is cleaned in-line without removing the filter and is used again in the staggered filtration system as described above.

In one exemplary embodiment, the method of processing a fluid comprises cleaning one or more pre-bleaching filters for future use in the staggered filtration system. Given the staggered configuration of the filtering system of the present invention and the rotation of fluid flow from one process flow step to the next, the frequency of filter cleanings in the present invention is kept to a minimum level.

In one exemplary embodiment, the step of cleaning a given filter in a three-filter staggered filter system takes place after the filter is used as a pre-bleaching filter 2. For example, in this exemplary embodiment, the method may comprise process flow steps in which a given filter changes from a post-bleaching filter to a pre-bleaching filter 1 to a pre-bleaching filter 2 and is then cleaned. After cleaning of the filter, the filter returns as a post-bleaching filter and is utilized as described above.

In a five-filter staggered filter system, a filter cleaning step desirably takes place after the filter is used as a pre-bleaching filter 3. For example, the method may comprise process flow steps in which a given filter changes from a post-bleaching filter 1 to a post-bleaching filter 2 to a pre-bleaching filter 1 to a pre-bleaching filter 2 to a pre-bleaching filter 3 and is then cleaned. As described above, after cleaning of the filter, the filter returns as a post-bleaching filter 1 and is utilized as described above.

7. Other Possible Process Step

The methods of processing a fluid may further comprise a number of additional steps including, but not limited to, any number of process control steps to monitor the quality and/or color of the fluid, such as an oil, during the process, as well as monitor other process parameters (e.g., pressure, temperature, etc.), adjusting flow valves to alter flow path of fluid through the staggered filter system, starting/stopping one or more pumps to adjust fluid flow through the staggered filter system, separating clay from adsorbent particles disposed on an inlet surface of one or more filters in the system, disposing of clay and/or adsorbent particles, and replacing damaged or unusable filters as needed.

As discussed above, in a typical method of processing a fluid, the method desirably comprises the step of adjusting one or more flow valves (and one or more pumps) so as to cause the fluid to flow along a different pathway through the staggered filtration system from one process flow step to a subsequent process flow step (i.e., rotating flow through the staggered filtration system as shown, for example, in Tables 1-2).

B. Exemplary Method for Processing Oil Using a Staggered Filtration System

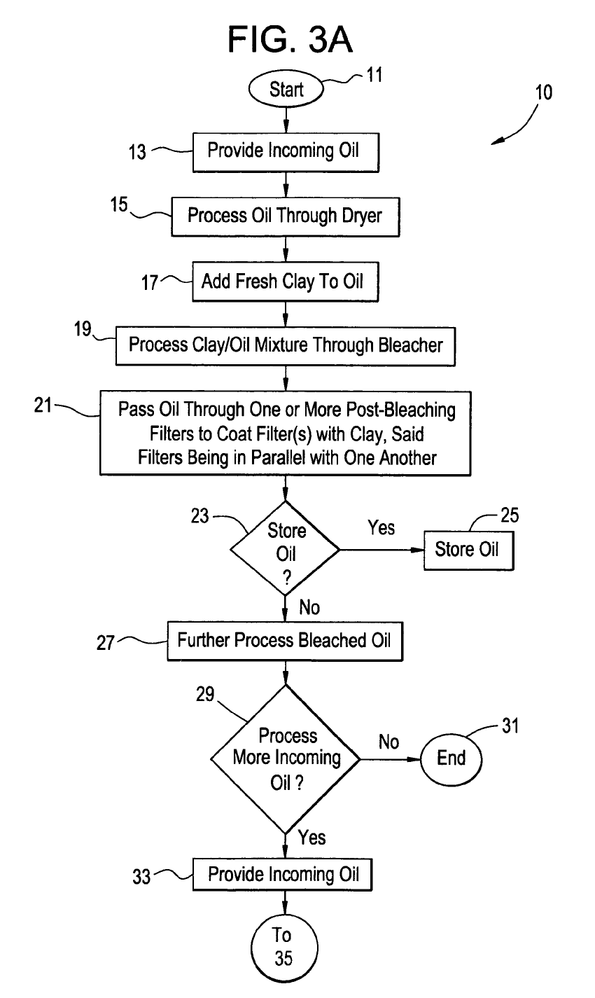

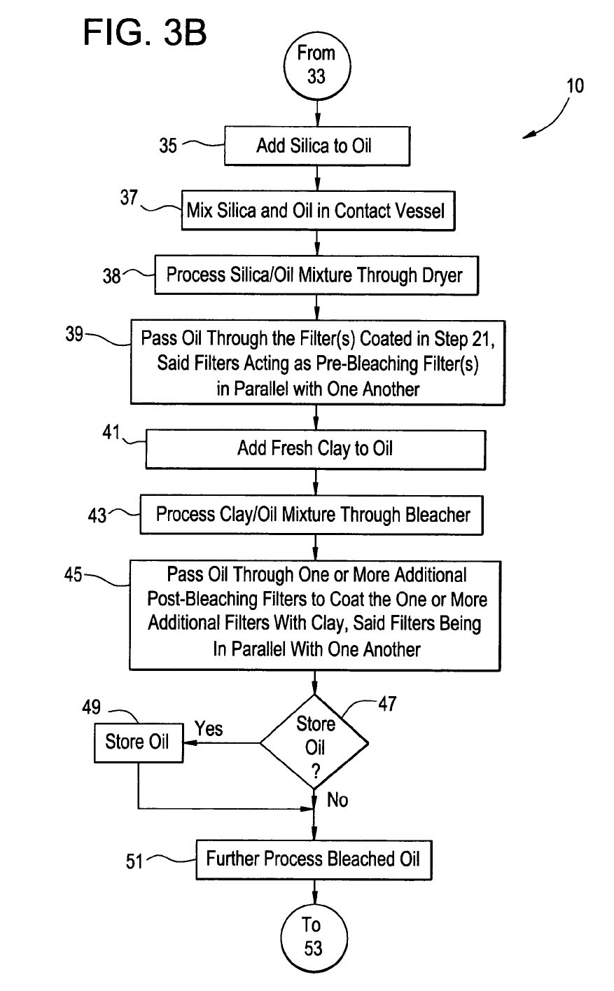

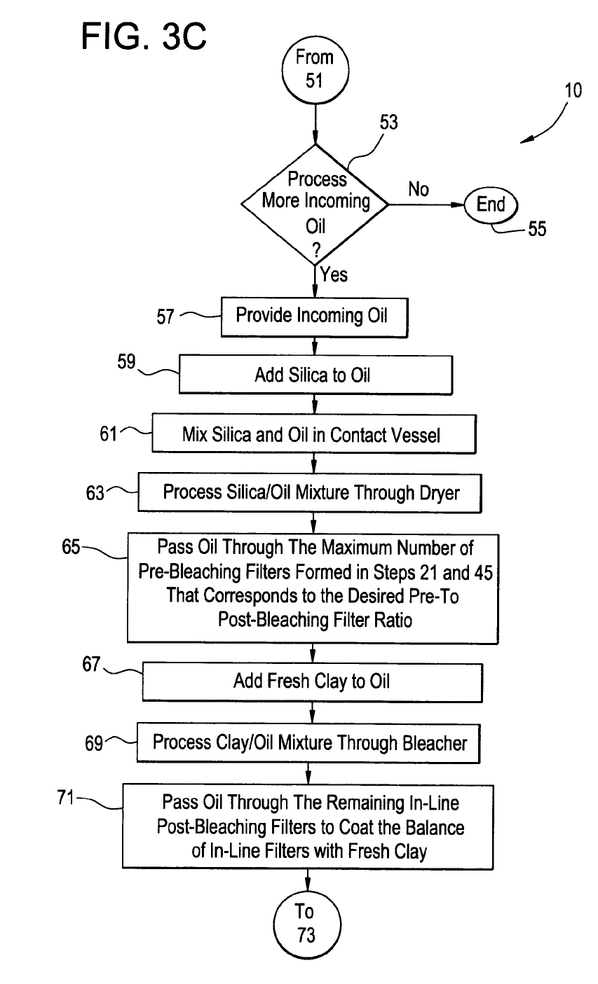

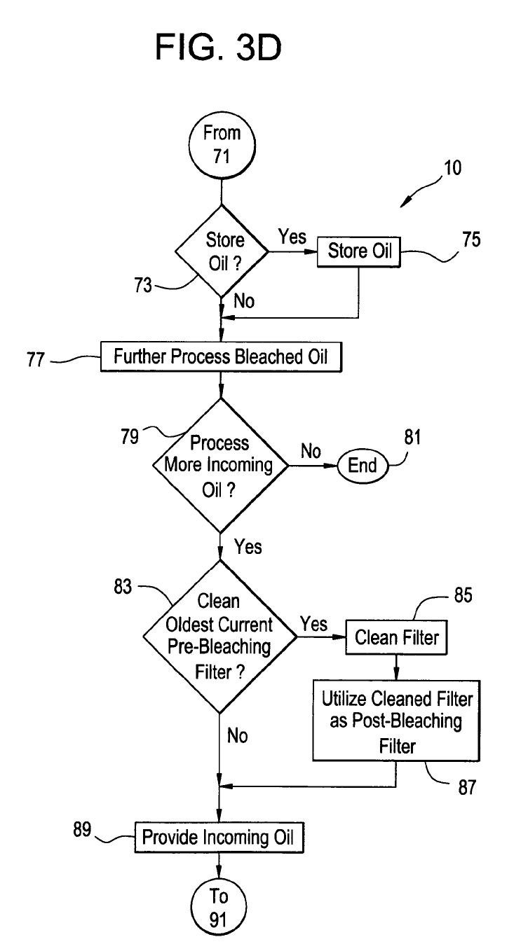

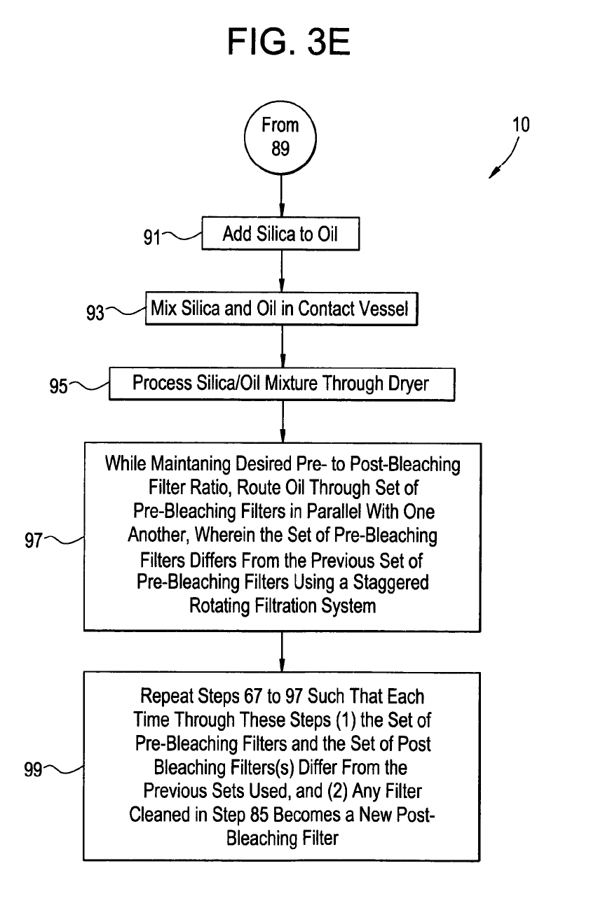

One exemplary method of processing oil according to the present invention is depicted in FIGS. 3A-3E. It should be noted that although exemplary method 10 shown in FIGS. 3A-3E involves a method of processing oil, such as in the production of an edible oil, exemplary method 10 may be used to process any fluid including, but not limited to, oils, fats, triglycerides; oil-, fat- and triglyceride-containing fluids; oil-, fat- and triglyceride precursor fluids that are convertible into oils, fats, triglycerides, edible oils, and biodiesel fuels.

As shown in FIG. 3A, exemplary method 10 starts at block 11, and proceeds to step 13, wherein incoming oil is provided. From step 13, exemplary method 10 proceeds to step 15, wherein oil is processed through a dryer (e.g., dryer 307). From step 15, exemplary method 10 proceeds to step 17, wherein fresh clay is added to the oil stream so as to, for example, adjust the color of the oil. From step 17, exemplary method 10 proceeds to step 19, wherein the clay/oil mixture is processed through a bleaching unit (e.g., bleaching unit 310).

From step 19 exemplary method 10 proceeds to step 21, wherein the clay-contained oil is filtered through one or more post-bleaching filters (e.g., filter 315 shown in FIG. 2A) resulting in a layer of fresh clay over at least a portion of an inlet surface of the one or more post-bleaching filters. When clay-contained oil is filtered through more than one post-bleaching filter in step 21, the post-bleaching filters are positioned in parallel with one another.

Once the oil passes through the one or more post-bleaching filters in step 21, exemplary method 10 proceeds to decision block 23. At decision block 23, a determination is made by an operator whether to store the bleached oil at this time. If a determination is made at decision block 23 to store the bleached oil, exemplary method 10 proceeds to step 25, wherein the bleached oil is stored. The stored bleached oil may be further processed at a later time (e.g., deodorized, etc.). If a determination is made at decision block 23 not to store the bleached oil at this time, exemplary method 10 proceeds to step 27, wherein the bleached oil is immediately further processed (e.g., deodorized, etc.).

From step 27, exemplary method 10 proceeds to decision block 29, wherein a determination is made by process control equipment or an operator whether to process more incoming oil. If a determination is made at decision block 29 not to process any more incoming oil, exemplary method 10 proceeds to step 31, wherein exemplary method 10 ends. If a determination is made at decision block 29 to process more incoming oil, exemplary method 10 proceeds to step 33, wherein additional incoming oil (e.g., more of the incoming oil of step 13) is provided.

From step 33, exemplary method 10 proceeds to step 35 shown in FIG. 3B, wherein an effective amount of adsorbent is added to the incoming oil so as to remove a desired amount of impurities from the oil. Typically, the effective amount of adsorbent is from about 0.01% to about 1.0% by weight based on a total weight of the oil and adsorbent. From step 35, exemplary method 10 proceeds to step 37, wherein the adsorbent and oil are brought into contact with one another within a mixing vessel (e.g., mixing vessel 305) and mixed for a desired amount of time. From step 37, exemplary method 10 proceeds to step 38, wherein the adsorbent/oil mixture is processed through a dryer (e.g., dryer 307). From step 38, exemplary method 10 proceeds to step 39, wherein oil is filtered through the filter(s) coated in step 21. In this step, the one or more coated filters act as pre-bleaching filter(s), which filter adsorbent particles from the oil. The pre-bleaching filter(s) are positioned in parallel with one another (e.g., filter 315 shown in FIG. 2B).

After passing through the one or more pre-bleaching filters in step 39, exemplary method 10 proceeds to step 41, wherein fresh clay is added to the oil stream. From step 41, exemplary method 10 proceeds to step 43, wherein the clay/oil mixture is processed through a bleaching unit. From step 43, exemplary method 10 proceeds to step 45, wherein the bleached oil is passed through one or more additional post-bleaching filters resulting in a layer of fresh clay over at least a portion of an inlet surface of one or more additional post-bleaching filters (e.g., filter 316 shown in FIG. 2B). When the clay-containing oil is filtered through more than one additional post-bleaching filter in step 45, the additional post-bleaching filters are positioned in parallel with one another and in series with the pre-bleaching filters of step 39.

Once the bleached oil passes through the one or more additional post-bleaching filters in step 45, exemplary method 10 proceeds to decision block 47. At decision block 47, a determination is made by process control equipment and/or an operator whether to store the bleached oil at this time. If a determination is made at decision block 47 to store the bleached oil, exemplary method 10 proceeds to step 49, wherein the bleached oil is store until further processed (e.g., deodorized, etc.). If a determination is made at decision block 47 not to store the bleached oil at this time, exemplary method 10 proceeds to step 51, wherein the bleached oil is immediately further processed (e.g., deodorized, etc.).

From step 51, exemplary method 10 proceeds to decision block 53 shown in FIG. 3C, wherein a determination is made by an operator whether to process more incoming oil. If a determination is made at decision block 53 not to process any more incoming oil, exemplary method 10 proceeds to step 55, wherein exemplary method 10 ends. If a determination is made at decision block 53 to process more incoming oil, exemplary method 10 proceeds to step 57, wherein additional incoming oil (e.g., more of the incoming oil of step 13) is provided.

From step 57, exemplary method 10 proceeds to step 59, wherein an effective amount of adsorbent is added to the incoming oil so as to remove a desired amount of impurities from the oil as described above. From step 59, exemplary method 10 proceeds to step 61, wherein the adsorbent and oil are allowed to mix in a contact vessel (e.g., such as mixing vessel 305). From step 61, exemplary method 10 proceeds to step 63, wherein the adsorbent/oil mixture is processed through a dryer. From step 63, exemplary method 10 proceeds to step 65, wherein oil is passed through a maximum number of pre-bleaching filters formed in steps 21 and 45 so as to correspond to a desired pre-bleaching filter to post-bleaching filter ratio (e.g., 1.5:1 or 2:1). The pre-bleaching filters (e.g., filters 315 and 316 shown in FIG. 2C) are in parallel with one another, and in series with the remaining post-bleaching filters (e.g., filter 317 shown in FIG. 2C).

From step 65, exemplary method 10 proceeds to step 67, wherein fresh clay is added to the oil. From step 67, exemplary method 10 proceeds to step 69, wherein the clay/oil mixture is processed through a bleaching unit. From step 69, exemplary method 10 proceeds to step 71, wherein the bleached oil is passed through the remaining in-line post-bleaching filters (e.g., filter 317 shown in FIG. 2C) resulting in a layer of fresh clay over at least a portion of an inlet surface of the balance of in-line filters in the system.

After passing the oil through the remaining in-line post-bleaching filters in step 71, exemplary method 10 proceeds to decision block 73 shown in FIG. 3D. At decision block 73, a determination is made by process control equipment and/or an operator whether to store the bleached oil at this time and until further processing (e.g., deodorized, etc.) at a later time. If a determination is made at decision block 73 to store the bleached oil, exemplary method 10 proceeds to step 75, wherein the bleached oil is store. If a determination is made at decision block 73 not to store the oil, exemplary method 10 proceeds directly to step 77, wherein the bleached oil is further processed (e.g., deodorized, etc.).

From step 77, exemplary method 10 proceeds to decision block 79, wherein a determination is made by an operator whether to process more incoming oil. If a determination is made at decision block 79 not to process any more incoming oil, exemplary method 10 proceeds to step 81, wherein exemplary method 10 ends. If a determination is made at decision block 79 to process more incoming oil, exemplary method 10 proceeds to decision block 83. At decision block 83, a determination is made whether to clean the oldest, current pre-bleaching filter in the system. In other words, a determination is made whether or not to clean the pre-bleaching filter that has been in operation the longest period of time as a pre-bleaching filter (e.g., pre-bleaching filter 3 shown in Table 2). If a determination is made at decision block 83 to clean the oldest, current pre-bleaching filter in the system, exemplary method 10 proceeds to step 85, wherein the filter is cleaned. Typically, the filter is cleaned in-line without removing the filter from the system. From step 85, exemplary method 10 proceeds to step 87, wherein the cleaned filter is utilized in the system as a post-bleaching filter. From step 87, exemplary method 10 proceeds to step 89, wherein additional incoming oil (e.g., more of the incoming oil of step 13) is provided.

Returning to decision block 83, if a determination is made at decision block 83 not to clean the oldest, current pre-bleaching filter in the system, exemplary method 10 proceeds directly to step 89. From step 89, exemplary method 10 proceeds to step 91 shown in FIG. 3E, wherein an effective amount of adsorbent is added to the incoming oil. From step 91, exemplary method 10 proceeds to step 93, wherein the adsorbent and oil are mixed in a contact vessel for the desired period of time. From step 93, exemplary method 10 proceeds to step 95, wherein the adsorbent/oil mixture is processed through a dryer. From step 95, exemplary method 10 proceeds to step 97, wherein, while maintaining the desired pre-bleaching filter to post-bleaching filter ratio, the incoming oil is routed through a new set of pre-bleaching filters, which are in parallel with one another, the new set of pre-bleaching filters being different from the previous set of pre-bleaching filters (e.g., the set of pre-bleaching filters utilized in step 65). The set of pre-bleaching filters in step 97 differs from the set of pre-bleaching filters in step 65 in that one pre-bleaching filter used in step 65 is now a post-bleaching filter in step 97 with the filters being rotated using the above-described staggered filtration system. See, for example, Tables 1-2.

From step 97, exemplary method 10 proceeds to step 99, wherein the above-described steps 67 to 97 are repeated such that each successive time through these process flow steps, (1) the new sets of pre-bleaching and post-bleaching filters differs from the previously used sets of pre-bleaching and post-bleaching filters via a filter rotation system using the above-described staggered filtration system, and (2) any filter cleaned in step 85 is utilized as a post-bleaching filter in the new set of post-bleaching filters.

At some point during which exemplary method 10 proceeds through steps 67 to 97, a determination is made at decision block 79 not to process any more incoming oil. At this time, exemplary method 10 proceeds to step 81, wherein exemplary method 10 ends.

It should be noted that the above-described staggered filter system and methods of the present invention may be utilized on fluid processing systems comprising any number of in-line filters (i.e., pre-bleaching filters in combination with post-bleaching filters). Regardless of the number of in-line filters within a given fluid processing system, fresh clay is utilized as described above in order to provide a desired color to the processed fluid, and results in one or more in-line, coated post-bleaching filters. Further, each in-line coated post-bleaching filter is subsequently utilized as a pre-bleaching filter for one or more consecutive process flow steps, and optionally again, after cleaning, as a post-bleaching filter for one or more consecutive process flow steps due to the rotation of filters from a given process flow step (e.g., process flow step n) to a subsequent process flow step (e.g., process flow step n+1). As discussed above, the total number of in-line filters is desirably utilized at a desired ratio of pre-bleaching filters to post-bleaching filters of equal to or greater than 1:1, and typically at least about 1.1:1 during one or more process flow steps of the process.

### III. Fluids Produced Using a Staggered Filtration System

The present invention is even further directed to fluids produced by the above-described methods of the present invention. Suitable fluids that may be produced using the above-described methods include, but are not limited to, oils, bleached oils, fats, edible oils, biodiesel fuels, and similar materials.

In one exemplary embodiment, the disclosed methods and apparatus are used to make edible oil. In one exemplary embodiment, a method of producing edible oil using a staggered filtration system comprises the steps of passing oil through the staggered filtration system during a process flow step so that oil passes through (i) two or more pre-bleaching filters A and B, wherein the two or more pre-bleaching filters are in parallel with one another, and (ii) one or more post-bleaching filters C, wherein the one or more post-bleaching filters are in parallel with one another (when two or more are present) and in series with the two or more pre-bleaching filters; and passing oil through the staggered filtration system during a subsequent process flow step in which at least one of post-bleaching filters C becomes a pre-bleaching filter. During the subsequent process flow step in which at least one of post-bleaching filters C becomes a pre-bleaching filter, at least one of pre-bleaching filters A and B typically becomes a post-bleaching filter. Desirably, during any given process flow step utilizing all of filters A, B and C, the staggered filtration system comprises more pre-bleaching filters than post-bleaching filters. As discussed above, typically, the ratio of pre-bleaching filters to post-bleaching filters is equal to or greater than 1:1, but can be at least 1.1:1, or as high as 2.0:1 or higher.

The method of producing edible oil using a staggered filtration system may further comprise one or more of the following steps:

(1) introducing fresh clay into the fluid stream so as adjust a color of the oil;

(2) coating one or more post-bleaching filters with a layer of fresh clay along at least a portion of an inlet surface (desirably, the entire inlet surface) of each filter;

(3) drying the oil to remove volatile components (e.g., water) from the oil;

(4) contacting oil with adsorbent particles to remove one or more impurities from the oil, wherein the one or more impurities comprise phospholipids, soaps, trace metals, or a combination thereof;

(5) bleaching the oil after the oil passes through one or more pre-bleaching filters A and B and before the oil passes through the one or more post-bleaching filters C;

(6) adjusting one or more flow valves so as to cause oil to flow along a different pathway through the staggered filtration system from one process flow step to a subsequent process flow step (see, Tables 1-2);

(7) cleaning a pre-bleaching filter, typically, the pre-bleaching filter that has been in use for the longest period of time;

(8) utilizing a cleaned pre-bleaching filter in the staggered filtration system initially as a post-bleaching filter;

(9) replacing a damaged or unusable filter when needed;

(10) storing bleached oil; and

(11) further processing the bleached oil, such as in a deodorization step.

In one desired embodiment, the method of producing edible oil using a staggered filtration system comprises each of steps (1) to (11) described above. Although TriSyl® adsorbent particles are described as being used throughout the exemplary methods disclosed herein, it should be understood that other adsorbent particles may be used in the disclosed methods. However, TriSyl® adsorbent particles are the most desirable adsorbent particles for use in the disclosed methods.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims.

1. A method of processing a fluid using a staggered filtration system, said method comprising the steps of:
passing the fluid through two or more pre-bleaching filters, wherein the two or more pre-bleaching filters are in parallel with one another; and
filtering the fluid through one or more post-bleaching filters, wherein the one or more post-bleaching filters are in parallel with one another and in series with the two or more pre-bleaching filters;
wherein the staggered filtration system has a ratio of pre-bleaching filters to post-bleaching filters of greater than 1:1.

2. The method of claim 1, further comprising:
introducing fresh clay into the fluid.

3. The method of claim 1 or 2, further comprising:
drying the fluid to remove volatile components from the fluid.

4. The method of any one of claims 1 to 3, further comprising:
contacting the fluid with adsorbent particles to remove one or more impurities from the fluid.

5. The method of claim 4, wherein the one or more impurities comprise phospholipids, soaps, trace metals, or a combination thereof.

6. The method of any one of claims 1 to 5, further comprising:
bleaching the fluid after said passing step and prior to said filtering step.

7. The method of claim 6, further comprising:
storing the bleached fluid after said filtering step.

8. The method of any one of claims 1 to 7, wherein said method comprises two or more process flow steps through the staggered filtration system.

9. The method of any one of claims 1 to 8, wherein said method comprises successive process flow steps n and (n+1), and filters A, B and C such that during process flow step n, filters A and B are pre-bleaching filters and filter C is a post-bleaching filter, and during process flow step (n+1), filters B and C are pre-bleaching filters and filter A is a post-bleaching filter.

10. The method of any one of claims 1 to 9, wherein from one process flow step to a subsequent process flow step through the staggered filtration system at least one post-bleaching filter becomes a pre-bleaching filter.

11. The method of any one of claims 1 to 10, further comprising:
adjusting one or more flow valves so as to cause the fluid to flow along a different pathway through the staggered filtration system from one process flow step to a subsequent process flow step.

12. The method of any one of claims 1 to 11, further comprising:
cleaning the pre-bleaching filter that has been in use in the staggered filtration system for the greatest amount of time.

13. A method of processing a fluid using a staggered filtration system, said method comprising the steps of:
passing the fluid through the staggered filtration system during a process flow step so that the fluid passes through (i) two or more pre-bleaching filters A and B, wherein the two or more pre-bleaching filters are in parallel with one another, and (ii) one or more post-bleaching filters C, wherein the one or more post-bleaching filters are in series with the two or more pre-bleaching filters, and if more than one post-bleaching filters C is present, the post-bleaching filters C are in parallel with one another; and
passing the fluid through the staggered filtration system during a subsequent process flow step in which at least one of post-bleaching filters C becomes a pre-bleaching filter.

14. The method of claim 13, wherein at least one of pre-bleaching filters A and B becomes a post-bleaching filter after cleaning said at least one of pre-bleaching filters A and B.

15. The method of claim 13 or 14, further comprising one or more of the following steps:
contacting the fluid with adsorbent particles to remove one or more impurities from the fluid, wherein the one or more impurities comprise phospholipids, soaps, trace metals, or a combination thereof;
bleaching the fluid after the fluid passes through the two or more pre-bleaching filters A and B and before the fluid passes through the one or more post-bleaching filters C;
introducing fresh clay into the fluid;
adjusting one or more flow valves so as to cause incoming fluid to flow along a different pathway through the staggered filtration system from one process flow step to a subsequent process flow step; and
cleaning one or more of the pre-bleaching filters for future use as a post-bleaching filter in the staggered filtration system.

16. The method of any one of claims 13 to 15, further comprising the following steps:
contacting the fluid with adsorbent particles to remove one or more impurities from the fluid, wherein the one or more impurities comprise phospholipids, soaps, trace metals, or a combination thereof;
bleaching the fluid after the fluid passes through the two or more pre-bleaching filters A and B and before the fluid passes through the one or more post-bleaching filters C;
introducing fresh clay into the fluid;
adjusting one or more flow valves so as to cause incoming fluid to flow along a different pathway through the staggered filtration system from one process flow step to a subsequent process flow step; and
cleaning one or more of the pre-bleaching filters for future use as a post-bleaching filter in the staggered filtration system.

17. The method of any one of claims 13 to 16, wherein during any given process flow step utilizing all of filters A, B and C, the staggered filtration system comprise more pre-bleaching filters than post-bleaching filters.

18. The method of any one of claim 4, 5, 15 or 16, wherein the adsorbent particles comprise TriSyl® adsorbent particles.

19. The method of any one of claims 1 to 18, wherein the ratio of pre-bleaching filters to post-bleaching filters is greater than about 1.1:1.

20. The method of any one of claims 1 to 19, wherein the ratio of pre-bleaching filters to post-bleaching filters is greater than about 2.0:1.

21. The method of any one of claims 1 to 20, wherein said method is a continuous process.

22. The method of any one of claims 1 to 21, wherein said fluid is an oil.

23. The method of any one of claims 1 to 22, wherein said method is a method for producing edible oil.

24. An apparatus suitable for processing a fluid, said apparatus comprising:
a bleaching unit; and
a staggered filtration system in-line with said bleaching unit, said staggered filtration system comprising:
two or more pre-bleaching filters positioned before said bleaching unit, wherein the two or more pre-bleaching filters are in parallel with one another, and
one or more post-bleaching filters positioned after said bleaching unit, wherein the one or more post-bleaching filters are in series with the two or more pre-bleaching filters, and if more than one post-bleaching filter is present, the post-bleaching filters are in parallel with one another;
wherein the staggered filtration system has a ratio of pre-bleaching filters to post-bleaching filters of greater than 1:1.

25. The apparatus of claim 24, further comprising:
a mixing vessel in-line with said bleaching unit and said staggered filtration system, said mixing vessel suitable for bringing the fluid into contact with a plurality of adsorbent particles so as to reduce an amount of impurities within the fluid;
a dryer in-line with said mixing vessel, said bleaching unit, and said staggered filtration system; and
a fluid storage vessel in-line with said mixing vessel, said bleaching unit, said staggered filtration system, and said dryer.

26. The apparatus of claim 24 or 25, further comprising:
one or more flow valves capable of routing incoming fluid along a different pathway through the staggered filtration system from one process flow step to a subsequent process flow step.

27. The apparatus of any one of claims 24 to 26, further comprising:
process control equipment capable of opening and closing one or more flow valves within said apparatus so as to route the fluid along a different pathway through the staggered filtration system from one process flow step to a subsequent process flow step.

28. The apparatus of any one of claims 24 to 27, wherein said fluid is an oil.

29. The apparatus of any one of claims 24 to 28, wherein said apparatus is used to produce edible oil.

30. An apparatus suitable for processing a fluid, said apparatus comprising:
a bleaching unit; and
a staggered filtration system in-line with said bleaching unit, said staggered filtration system comprising:
two or more pre-bleaching filters positioned before said bleaching unit, wherein the two or more pre-bleaching filters are in parallel with one another, and
one or more post-bleaching filters positioned after said bleaching unit, wherein the one or more post-bleaching filters are in series with the two or more pre-bleaching filters, and if more than one post-bleaching filter is present, the post-bleaching filters are in parallel with one another.

31. The apparatus of claim 30, wherein the staggered filtration system has a ratio of pre-bleaching filters to post-bleaching filters of greater than 1:1.

32. A method of processing a fluid using a staggered filtration system, said method comprising the steps of:
passing the fluid through two or more pre-bleaching filters, wherein the two or more pre-bleaching filters are in parallel with one another; and
filtering the fluid through one or more post-bleaching filters, wherein the one or more post-bleaching filters are in parallel with one another and in series with the two or more pre-bleaching filters.

33. The method of claim 32, wherein the staggered filtration system has a ratio of pre-bleaching filters to post-bleaching filters of greater than 1:1.
